(19) United States
(12) Patent Application Publication
(10) Pub. No.: US 2025/0203295 A1
(43) Pub. Date: Jun. 19, 2025

(54) VIBRATION APPARATUS AND APPARATUS INCLUDING THE SAME

(71) Applicant: LG Display Co., Ltd., Seoul (KR)

(72) Inventors: HwaYoul LEE, Paju-si (KR); Sooyoun KIM, Paju-si (KR); YongWoo LEE, Paju-si (KR); Uihyeon JEONG, Paju-si (KR); Daesu KIM, Paju-si (KR)

(73) Assignee: LG Display Co., Ltd., Seoul (KR)

(21) Appl. No.: 18/675,477

(22) Filed: May 28, 2024

(30) Foreign Application Priority Data
Dec. 15, 2023 (KR) 10-2023-0183763

(51) Int. Cl. H04R 17/00; H04R 15/00

(52) U.S. Cl. CPC H04R 17/00; H04R 15/00; H04R 2400/03

(57) ABSTRACT

A vibration apparatus may include a first electrode layer, a second electrode layer, and a first vibration layer and a second vibration layer between the first electrode layer and the second electrode layer. The first vibration layer and the second vibration layer may have different deformation characteristics from each other. An apparatus including a vibration member and a vibration apparatus is also disclosed.

### CROSS-REFERENCE TO RELATED APPLICATION

This application claims the benefit of and priority to Korean Patent Application No. 10-2023-0183763 filed in the Republic of Korea on Dec. 15, 2023, the entirety of which is incorporated herein by reference for all purposes.

### BACKGROUND

### 1. Technical Field

The present disclosure relates to apparatuses, and particularly to, for example, without limitation, a vibration apparatus and an apparatus including the same.

### 2. Description of the Related Art

Speakers applied to apparatuses may be, for example, an actuator including a magnet and a coil. In a case where an actuator is applied to an apparatus, there is a drawback where a thickness of an apparatus is thick. Piezoelectric devices for implementing a thin thickness are attracting much attention.

Apparatuses including a piezoelectric device are lightweight and have low power consumption, and thus, are being used for various purposes. In piezoelectric devices, a lowest resonance frequency increases due to high stiffness, and due to this, a sound pressure level of a low-pitched sound band is easily insufficient. Therefore, apparatuses including a piezoelectric device have a technical problem where a sound pressure level of the low-pitched sound band is insufficient.

The description of the related art should not be assumed to be prior art merely because it is mentioned in or associated with this section. The description of the related art may include information that describes one or more aspects of the subject technology, and the description in this section does not limit the invention.

### SUMMARY

Therefore, the inventors have recognized the problems and disadvantages of the related art, including the limitations described above, and have performed extensive research and experiments for enhancing a sound characteristic and/or a sound pressure level characteristic of a low-pitched sound band of a vibration apparatus. Based on extensive research and experiments, the inventors have invented a new structure of a vibration apparatus and an apparatus including the same which may enhance a sound characteristic and/or a sound pressure level characteristic of the low-pitched sound band of the apparatus.

An aspect of the present disclosure is directed to providing a vibration apparatus and an apparatus including the same which may enhance a sound characteristic and/or a sound pressure level characteristic of a low-pitched sound band and may enhance a sound characteristic and/or a sound pressure level characteristic of a middle-high-pitched sound band.

Additional features and aspects will be set forth in the description that follows, and in part will be apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

A vibration apparatus according to an example embodiment of the present disclosure may include a first electrode layer, a second electrode layer, and a first vibration layer and a second vibration layer between the first electrode layer and the second electrode layer, the first vibration layer and the second vibration layer having different deformation characteristics from each other.

An apparatus according to an example embodiment of the present disclosure may include a vibration member, and a vibration generating apparatus configured to vibrate the vibration member. The vibration generating apparatus may include a first electrode layer, a second electrode layer, and a first vibration layer and a second vibration layer between the first electrode layer and the second electrode layer, the first vibration layer and the second vibration layer having different deformation characteristics from each other.

According to an example embodiment of the present disclosure, a vibration apparatus and an apparatus including the same may be provided where a sound characteristic and/or a sound pressure level characteristic of a low-pitched sound band may be enhanced, and a sound characteristic and/or a sound pressure level characteristic of a middle-high-pitched sound band may be enhanced.

According to an example embodiment of the present disclosure, a piezoelectric device which is lightweight and has low power consumption may be used, and a sound characteristic and/or a sound pressure level characteristic of a low-pitched sound band may be enhanced, thereby providing a vibration apparatus and an apparatus including the same which is implemented or configured to be lightweight or have low power consumption.

A vibration apparatus and an apparatus including the same according to an example embodiment of the present disclosure may include a Pb-free piezoelectric material, and thus, may realize an effect of preventing the toxicity of Pb and environmental pollution caused by a harmful material occurring in a sintering process, an effect of decreasing a production harmful/restrictive material, an effect of providing an environment-friendly product, and an effect of replacing a harmful material.

According to an example embodiment of the present disclosure, since it is configured as one vibration apparatus capable of implementing low and middle sounds, an arrangement area of the vibration apparatus disposed in an apparatus may be reduced, thereby improving an appearance aesthetics of the apparatus.

According to an example embodiment of the present disclosure, since low or middle sounds may be implemented with one vibration apparatus, a cost of the vibration apparatus may be reduced due to the reduction in the number of parts.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the present disclosure. Nothing in this section should be taken as a limitation on the present disclosure. Further aspects and advantages are discussed below in conjunction with aspects of the disclosure.

It is to be understood that both the foregoing description and the following description are examples and explanatory and are intended to provide further explanation of the inventive concepts as claimed.

### BRIEF DESCRIPTION OF THE DRAWINGS

The accompanying drawings, which are included to provide a further understanding of the disclosure, are incorporated in and constitute a part of this disclosure, illustrate aspects and embodiments of the disclosure, and together with the description serve to explain principles and examples of the disclosure.

FIG. 1 illustrates a vibration apparatus according to an example embodiment of the present disclosure.

FIG. 2 is a cross-sectional view taken along line I-I′ illustrated in FIG. 1 according to an example embodiment of the present disclosure.

FIG. 3 is a cross-sectional view taken along line II-II′ illustrated in FIG. 1 according to an example embodiment of the present disclosure.

FIG. 4 is a cross-sectional view taken along line III-III′ illustrated in FIG. 1 according to an example embodiment of the present disclosure.

FIG. 5 illustrates a vibration apparatus according to another example embodiment of the present disclosure.

FIG. 6 illustrates a vibration apparatus according to another example embodiment of the present disclosure.

FIG. 7 illustrates a vibration apparatus according to another example embodiment of the present disclosure.

FIG. 8 illustrates a vibration apparatus according to another example embodiment of the present disclosure.

FIG. 9 illustrates an apparatus according to an example embodiment of the present disclosure.

FIG. 10 is a cross-sectional view taken along line IV-IV′ illustrated in FIG. 9 according to an example embodiment of the present disclosure.

FIG. 11 is a plan view of an apparatus including a vibration apparatus according to another example embodiment of the present disclosure.

FIG. 12 illustrates a vibration apparatus for a vehicle according to another example embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and/or convenience.

### DETAILED DESCRIPTION

Reference is now made in detail to embodiments of the present disclosure, examples of which may be illustrated in the accompanying drawings. In the following description, when a detailed description of well-known methods, functions, structures or configurations may unnecessarily obscure aspects of the present disclosure, the detailed description thereof may have been omitted for brevity. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete, to assist those skilled in the art to understand the inventive concepts without limiting the protected scope of the present disclosure.

Shapes, dimensions (e.g., sizes, lengths, widths, heights, thicknesses, locations, radii, diameters, and areas), proportions, ratios, angles, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., layers, films, regions, components, sections, members, parts, regions, areas, portions, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise.

The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

In describing a positional relationship, when the positional relationship between two parts (e.g., layers, films, regions, components, sections, or the like) is described, for example, using “on,” “upon,” “on top of,” “over,” “under,” “above,” “below,” “beneath,” “near,” “close to,” “adjacent to,” “beside,” “next to,” “at or on a side of,” or the like, one or more parts may be located between two other parts unless a more limiting term, such as “immediate(ly),” “direct(ly),” or “close(ly),” is used. For example, when a structure is described as being positioned “on,” “upon,” “on top of,” “over,” “under,” “above,” “below,” “beneath,” “near,” “close to,” “adjacent to,” “beside,” “next to,” “at or on a side of,” or the like another structure, this description should be construed as including a case in which the structures contact each other as well as a case in which one or more additional structures are disposed or interposed therebetween. Furthermore, the terms “front,” “rear,” “back,” “left,” “right,” “top,” “bottom,” “downward,” “upward,” “upper,” “lower,” “up,” “down,” “column,” “row,” “vertical,” “horizontal,” and the like refer to an arbitrary frame of reference.

Spatially relative terms, such as “below,” “beneath,” “lower,” “on,” “above,” “upper” and the like, may be used to describe a correlation between various elements (e.g., layers, films, regions, components, sections, or the like) as shown in the drawings. The spatially relative terms are to be understood as terms including different orientations of the elements in use or in operation in addition to the orientation depicted in the drawings. For example, if the elements shown in the drawings are turned over, elements described as “below” or “beneath” other elements would be oriented “above” other elements. Thus, the term “below,” which is an example term, may include all directions of “above” and “below.” Likewise, an exemplary term “above” or “on” may include both directions of “above” and “below.”

In describing a temporal relationship, when the temporal order is described as, for example, “after,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly)” is used.

The terms, such as “below,” “lower,” “above,” “upper” and the like, may be used herein to describe a relationship between element(s) as illustrated in the drawings. It will be understood that the terms are spatially relative and based on the orientation depicted in the drawings.

It is understood that, although the terms “first,” “second,” or the like may be used herein to describe various elements (e.g., layers, films, regions, components, sections, members, parts, regions, areas, portions, steps, operations, and/or the like), these elements should not be limited by these terms, for example, to any particular order, sequence, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

For the expression that an element (e.g., layer, film, region, component, section, or the like) is “connected,” “coupled,” “attached,” “adhered,” or the like to another element, the element may not only be directly connected, coupled, attached, adhered, or the like to another element, but also be indirectly connected, coupled, attached, adhered, or the like to another element with one or more intervening elements disposed or interposed between the elements, unless otherwise specified.

For the expression that an element (e.g., layer, film, region, component, section, or the like) “contacts,” “overlaps,” or the like with another element, the element may not only directly contact, overlap, or the like with another element, but also indirectly contact, overlap, or the like with another element with one or more intervening elements disposed or interposed between the elements, unless otherwise specified.

The phrase that an element (e.g., layer, film, region, component, section, or the like) is “provided,” “disposed,” “connected,” “coupled,” or the like in, on, with or to another element may be understood, for example, as that at least a portion of the element is provided, disposed, connected, coupled, or the like in, on, with or to at least a portion of another element, or that the entirety of the element is provided, disposed, connected, coupled, or the like in, on, with or to another element. The phrase that an element (e.g., layer, film, region, component, section, or the like) “contacts,” “overlaps,” or the like with another element may be understood, for example, as that at least a portion of the element contacts, overlaps, or the like with a least a portion of another element, that the entirety of the element contacts, overlaps, or the like with a least a portion of another element, or that at least a portion of the element contacts, overlaps, or the like with the entirety of another element.

The terms such as a “line” or “direction” should not be interpreted only based on a geometrical relationship in which the respective lines or directions are parallel or perpendicular to each other, and may be meant as lines or directions having wider directivities within the range within which the components of the present disclosure may operate functionally. For example, the terms “first direction,” “second direction,” and the like, such as a direction parallel or perpendicular to “x-axis,” “y-axis,” or “z-axis,” should not be interpreted only based on a geometrical relationship in which the respective directions are parallel or perpendicular to each other, and may be meant as directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, and the third item.

The expression of a first element, a second elements “and/or” a third element should be understood as one of the first, second and third elements or as any or all combinations of the first, second and third elements. By way of example, A, B and/or C may refer to only A; only B; only C; any of A, B, and C (e.g., A, B, or C); some or some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element (e.g., layer, film, region, component, sections, or the like) is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” For example, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

Features of various embodiments of the present disclosure may be partially or entirely coupled to or combined with each other, may be technically associated with each other, and may be variously inter-operated, linked or driven together. The embodiments of the present disclosure may be implemented or carried out independently of each other, or may be implemented or carried out together in a co-dependent or related relationship. In one or more aspects, the components of each apparatus according to various example embodiments of the present disclosure are operatively coupled and configured.

Unless otherwise defined, the terms (including technical and scientific terms) used herein have the same meaning as commonly understood by one of ordinary skill in the art to which example embodiments belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In present disclosure, a display apparatus including a vibration apparatus may be implemented with a user interface device such as a central control panel in automobiles, and thus, may be applied to vehicles.

Features of various embodiments of the present disclosure may be partially or overall coupled to or combined with each other, and may be variously inter-operated with each other and driven technically as those skilled in the art may sufficiently understand. The embodiments of the present disclosure may be carried out independently from each other, or may be carried out together in co-dependent relationship.

In the following description, various example embodiments of the present disclosure are described in detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

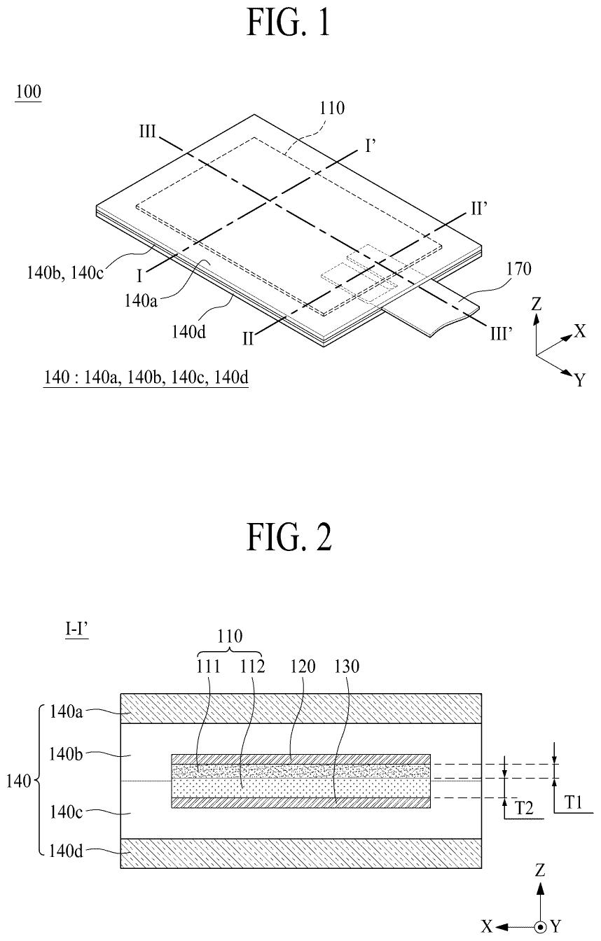

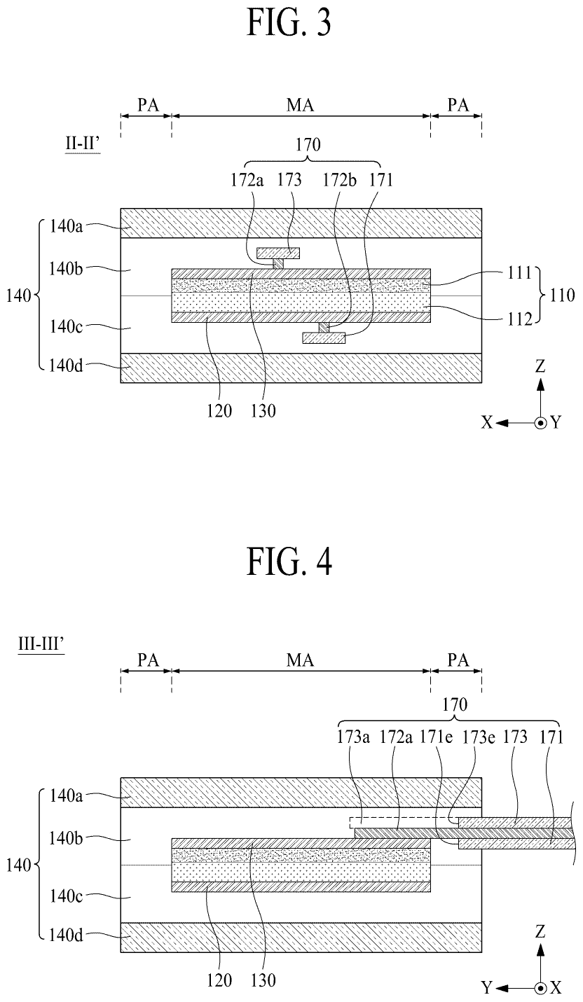

FIG. 1 illustrates a vibration apparatus according to an example embodiment of the present disclosure. FIG. 2 is a cross-sectional view taken along line I-I′ illustrated in FIG. 1 according to an example embodiment of the present disclosure. FIG. 3 is a cross-sectional view taken along line II-II′ illustrated in FIG. 1 according to an example embodiment of the present disclosure. FIG. 4 is a cross-sectional view taken along line III-III′ illustrated in FIG. 1 according to an example embodiment of the present disclosure.

Referring to FIGS. 1 to 4, the vibration apparatus 100 according to an example embodiment of the present disclosure may include a vibration generating part 110.

The vibration generating part 110 may be configured to vibrate with a piezoelectric effect based on a driving signal. The vibration generating part 110 may include at least one of a piezoelectric inorganic material, a piezoelectric organic material, and a relaxor ferroelectric material. For example, the vibration generating part 110 may be a vibration part, a vibration device, a piezoelectric device, a piezoelectric device part, a piezoelectric device layer, a piezoelectric material, a piezoelectric vibration part, or a piezoelectric vibration layer, but embodiments of the present disclosure are not limited thereto.

The vibration generating part 110 according to an example embodiment of the present disclosure may include a first vibration layer 111 and a second vibration layer 112. The vibration generating part 110 may be provided between a first electrode layer 120 and a second electrode layer 130. For example, the first vibration layer 111 and the second vibration layer 112 may be provided between the first electrode layer 120 and the second electrode layer 130. For example, the first vibration layer 111 and the second vibration layer 112 may be stacked to overlap each other between the first electrode layer 120 and the second electrode layer 130.

The vibration generating part 110 may include a circular plate shape, a polygonal plate shape, an oval shape, or a ring shape, but embodiments of the present disclosure are not limited thereto. For example, each of the first vibration layer 111 and the second vibration layer 112 may include a circular plate shape, a polygonal plate shape, an oval shape, or a ring shape, but embodiments of the present disclosure are not limited thereto.

The vibration generating part 110 may include a lead zirconate titanate (PZT)-based piezoelectric material including Pb, zirconium (Zr), and titanium (Ti) having a strong piezoelectric characteristic, but is not limited thereto and may include a Pb-free piezoelectric material so as to prevent the toxicity of Pb and environmental pollution caused by a harmful material occurring in a sintering process. For example, the Pb-free piezoelectric material may have a problem where performance and reliability are lower than those of the PZT-based piezoelectric material. For example, the Pb-free piezoelectric material may have problem where the reliability of a piezoelectric material is affected by a low curie temperature and a piezoelectric characteristic is low due to a low piezoelectric constant. Accordingly, the inventors have invented a piezoelectric material having a characteristic which is the same as or similar to a Pb-based piezoelectric material, based on various research and experiments. This will be described below.

The first vibration layer 111 and the second vibration layer 112 according to an example embodiment of the present disclosure may have different deformation characteristics from each other. For example, the first vibration layer 111 and the second vibration layer 112 may include piezoelectric materials having different deformation characteristics among Pb-free piezoelectric materials. For example, the different deformation characteristics may include a phase transition deformation characteristic and an electric field induced deformation characteristic. For example, one of the first vibration layer 111 and the second vibration layer 112 may be composed of a relaxor ferroelectric material having the phase transition deformation characteristic. For example, the other of the first vibration layer 111 and the second vibration layer 112 may be composed of a ferroelectric material or a piezoelectric material having the electric field induced deformation characteristic. For example, the first vibration layer 111 may include the relaxor ferroelectric material, and the second vibration layer 112 may include the ferroelectric material or the piezoelectric material. The relaxor ferroelectric material may be a phase transition deformation material, but embodiments of the present disclosure are not limited thereto. The ferroelectric material or the piezoelectric material may be a piezoelectric material, but embodiments of the present disclosure are not limited thereto.

The relaxor ferroelectric materials may be irregular crystals, a specific class of ferroelectric materials that exhibit a high degree of disorder in their crystalline structure, unlike related art ferroelectric materials. The term “relaxor” refers to a relaxation characteristic exhibited by a dielectric response of these materials. For example, the relaxor ferroelectric materials may have a crystalline structure without long-range order, and randomly distributed polar nanoregions (PNRs) exist within the crystal. For example, a dielectric constant of the relaxor ferroelectric materials may change gradually when measuring the dielectric constant according to temperature changes due to the polar nanoregions (PNRs), and the dielectric constant may have frequency dependence. For example, the relaxor ferroelectric materials may have a high dielectric constant at a certain temperature range, and the crystalline structure and a dynamic property may change sensitively to frequency and temperature. Thereby, the relaxor ferroelectric materials may have a high piezoelectric coefficient, a high dielectric constant, a high sensitivity, and a wide operating temperature range, and may have large strain characteristic due to phase transition.

A piezoelectric effect may be a characteristic that generates an electrical charge in response to mechanical stress or strain, or cause mechanical deformation or shape deformation when an electric field is applied.

Compared to the piezoelectric materials, the relaxor ferroelectric materials have a relatively large strain due to phase transitions, converting electrical energy into mechanical energy, but have relatively low frequency response characteristics. The relaxor ferroelectric materials are capable of large strain, enabling the implementation of low sounds. However, when composed solely of relaxor ferroelectric materials, it is difficult to implement all audible frequency ranges except for the low-pitched sounds. According to an example embodiment of the present disclosure, since the relaxor ferroelectric materials may implement low-pitched sounds and the piezoelectric materials may implement middle-pitched sounds, a vibration apparatus 100 capable of implementing low sounds and middle-high-pitched sounds may be provided by configuring the relaxor ferroelectric materials and the piezoelectric materials together. For example, the audible frequency may be 20 Hz to 20 kHz, but embodiments of the present disclosure are not limited thereto.

The relaxor ferroelectric materials may include a barium titanate (BT)-based material. For example, the barium titanate (BT)-based material may form a solid solution by adding a three-component oxide including lanthanum (La) to [Bi, Na, K] TiO₃-based matrix material containing Bi, Na, K, Ti, and O as main components, and may have a pseudo-cubic perovskite crystalline structure. For example, the barium titanate (BT)-based relaxor ferroelectric material may have a characteristic of a phase transformation from a pseudo-cubic at an initial state to a rhombohedral crystalline structure or a tetragonal crystalline structure by an electric field applied from an outside, thereby may have a large deformation characteristic. For example, the large deformation characteristic of the barium titanate (BT)-based relaxor ferroelectric material may be implemented or realized when a low-frequency is applied.

For example, the barium titanate (BT)-based relaxor ferroelectric material may be represented by the following Formula 1.

0.99[(Bi_{0.5}Na_{0.4}K_{0.1})₁₋ₓLaₓTiO₃]-0.01[Ba_{0.7}Sr_{0.3}TiO₃]+y mol % CuO (x=0.02˜0.025,y=0.1˜2.0) Formula 1

For example, ferroelectric or piezoelectric characteristics may be exhibited according to a content of lanthanum (La).

Ferroelectric or piezoelectric materials may have a characteristic in which a potential difference is generated by a dielectric polarization caused by a relative position change of positive (+) ions and negative (−) ions when pressure or twisting occurs on the crystalline structure by an external force, and may have a characteristic in which a vibration is generated by an electric field according to a reverse applied voltage. For example, the ferroelectric or piezoelectric materials may include a ceramic-based material capable of implementing a relatively high vibration, or may include piezoelectric ceramic having a perovskite crystalline structure. The perovskite crystalline structure may have a piezoelectric and/or inverse piezoelectric effect and may be a plate-shaped structure having an orientation property.

The piezoelectric ceramic may include single crystalline ceramic having a single crystalline structure, or may include polycrystalline ceramic or a ceramic material having a polycrystalline structure. A piezoelectric material of a single crystalline ceramic may include α-AlPO₄, α-SiO₂, LiNbO₃, Tb₂(MoO₄)₃, Li₂B₄O₇, or ZnO, but embodiments of the present disclosure are not limited thereto. A piezoelectric material of a polycrystalline ceramic may include a lead zirconate titanate (PZT)-based material including lead (Pb), zirconium (Zr), and titanium (Ti), but embodiments of the present disclosure are not limited thereto. For example, the polycrystalline ceramic may include a lead zirconate nickel niobate (PZNN)-based material including lead (Pb), zirconium (Zr), nickel (Ni), and niobium (Nb).

The ferroelectric or piezoelectric materials may include a potassium sodium niobate (KNN)-based piezoelectric material including potassium (K), sodium (Na), and niobium (Nb), and/or a barium titanate (BT)-based piezoelectric material, and a bismuth (Bi)-based piezoelectric material. For example, the KNN-based piezoelectric material may include (K,Na)NbO₃, but embodiments of the present disclosure are not limited thereto. For example, the BT-based piezoelectric material may include (Ba,Ca)TiO₃—Ba(Ti,Zr)O₃, but embodiments of the present disclosure are not limited thereto. For example, templated grain growth (TGG) may be applied to the KNN-based piezoelectric material, or may not be applied thereto, but embodiments of the present disclosure are not limited thereto.

For example, the potassium sodium niobate (KNN)-based piezoelectric material may be represented by the following Formula 2.

0.96(Na_{0.5}K_{0.5})(Nb_{0.932}Sb_{0.068})-0.01(CaZrO₃)+0.03(Bi_{0.5}Ag_{0.5})ZrO₃+x mol % Fe₂O₃ (X=0.1˜1.0) Formula 2

Referring to FIG. 2, the first vibration layer 111 and the second vibration layer 112 according to an example embodiment of the present disclosure may have different thicknesses from each other. For example, the first vibration layer 111 may have a thickness which is equal to or thinner than a thickness of the second vibration layer 112. The first vibration layer 111 may be configured to have a first thickness T1, and the second vibration layer 112 may be configured to have a second thickness T2. For example, the first vibration layer 111 may be composed of a relaxor ferroelectric material having the phase transition deformation characteristic, and the second vibration layer 112 may be composed of a ferroelectric material or a piezoelectric material having the electric field induced deformation characteristic. For example, the first vibration layer 111 may be composed of a relaxor ferroelectric material, and thus may have a large deformation characteristic, but a deformation rate may decrease or not deformed under low electric field conditions. Therefore, the first vibration layer 111 according to an example embodiment of the present disclosure may be configured to have a thickness thinner than that of the second vibrating layer 112, so that a higher applied electric field may be induced than the second vibrating layer 112. As a result, the first vibration layer 111 and the second vibration layer 112 may be simultaneously driven, thereby implementing or realizing the large deformation characteristics of the first vibration layer 111 and the second vibration layer 112.

The first vibration layer 111 and the second vibration layer 112 may have different volumes from each other. For example, the first vibration layer 111 may have a volume which is equal to or smaller than a volume of the second vibration layer 112. For example, the first vibration layer 111 may be composed of a volume of 40 vol % or less based on a total volume including the first vibration layer 111 and the second vibration layer 112. Therefore, the first vibration layer 111 may be induced a higher applied electric field than the second vibrating layer 112. As a result, the first vibration layer 111 and the second vibration layer 112 may be simultaneously driven, thereby implementing or realizing the large deformation characteristics of the first vibration layer 111 and the second vibration layer 112.

The vibration apparatus 100 according to an example embodiment of the present disclosure may include a first electrode layer 120 and a second electrode layer 130 facing each other with the vibration generating part 110 therebetween.

The first electrode layer 120 may be disposed at a first surface (or an upper surface) of the vibration generating part 110. The first electrode layer 120 may have the same size as that of the vibration generating part 110, or the first electrode layer 120 may have a size which is less than that of the vibration generating part 110.

The second electrode layer 130 may be disposed at a second surface (or a lower surface) which is different from or opposite to the first surface of the vibration generating part 110. The second electrode layer 130 may have substantially a same size as that of the vibration generating part 110, or the second electrode layer 130 may have a size which is less than that of the vibration generating part 110. For example, the second electrode layer 130 may have substantially a same shape as that of the first electrode layer 120 or the vibration generating part 110, but embodiments of the present disclosure are not limited thereto.

According to an example embodiment of the present disclosure, to prevent an electrical connection (or short circuit) between the first electrode layer 120 and the second electrode layer 130, each of the first electrode layer 120 and the second electrode layer 130 may be formed at the other portion, except an edge portion (or a periphery portion), of the vibration generating part 110. For example, the first electrode layer 120 may be entirely formed at the other portion, except an edge portion (or a periphery portion), of the first surface of the vibration generating part 110. For example, the second electrode layer 130 may be entirely formed at the other portion, except an edge portion (or a periphery portion), of the second surface of the vibration generating part 110. For example, a distance between a lateral surface (or an outer sidewall) of each of the first electrode layer 120 and the second electrode layer 130 and a lateral surface (or an outer sidewall) of the vibration generating part 110 may be at least 0.5 mm or more. For example, a distance between the lateral surface of each of the first electrode layer 120 and the second electrode layer 130 and the lateral surface of the vibration generating part 110 may be at least 1 mm or more, but embodiments of the present disclosure are not limited thereto.

One or more of the first electrode layer 120 and the second electrode layer 130 according to an example embodiment of the present disclosure may include a transparent conductive material, a semitransparent conductive material, or an opaque conductive material. For example, the transparent or semitransparent conductive material may include indium tin oxide (ITO) or indium zinc oxide (IZO), but embodiments of the present disclosure are not limited thereto. The opaque conductive material may include gold (Au), silver (Ag), platinum (Pt), palladium (Pd), molybdenum (Mo), magnesium (Mg), carbon, or Ag including a glass frit, or may include an alloy thereof, but embodiments of the present disclosure are not limited thereto. For example, each of the first electrode layer 120 and the second electrode layer 130 may include Ag having a low resistivity, so as to enhance an electrical characteristic and/or a vibration characteristic of the vibration generating part 110. For example, the carbon may be a carbon material including graphite, carbon black, ketjen black, and carbon nanotube, but embodiments of the present disclosure are not limited thereto.

The vibration generating part 110 may be polarized (or poling) by a certain voltage applied to the first electrode layer 120 and the second electrode layer 130 in a certain temperature atmosphere or a temperature atmosphere which is changed from a high temperature to a room temperature, but embodiments of the present disclosure are not limited thereto. For example, a polarization direction (or a poling direction) formed in the vibration generating part 110 may be formed or aligned (or arranged) from the first electrode layer 120 to the second electrode layer 130, but is not limited thereto and may be formed or aligned (or arranged) from the second electrode layer 130 to the first electrode layer 120.

The vibration generating part 110 may include the first vibration layer 111 and the second vibration layer 112 having different deformation characteristics from each other. For example, the first vibration layer 111 and the second vibration layer 112 may be configured to stacked to overlap each other between the first electrode layer 120 and the second electrode layer 130. The first vibration layer 111 and the second vibration layer 112 may alternately and repeatedly contract and/or expand based on an inverse piezoelectric effect based on a driving signal applied from the outside to the first electrode layer 120 and the second electrode layer 130 by a driving circuit to vibrate. For example, the first vibration layer 111 may include the relaxor ferroelectric material, and the second vibration layer 112 may include the ferroelectric material. Accordingly, an electric field applied to the first vibration layer 111 and the second vibration layer 112 may act differently, and it may be necessary that an electric field applied to the first vibration layer 111 is induced to be greater than an electric field applied to the second vibration layer 112. Therefore, the first vibration layer 111 according to an example embodiment of the present disclosure may be configured to have a thickness thinner than that of the second vibrating layer 112, so that a higher applied electric field may be induced than the second vibrating layer 112. As a result, the first vibration layer 111 and the second vibration layer 112 may be simultaneously driven. For example, the first vibration layer 111 and the second vibrating layer 112 may vibrate in a vertical direction (or a thickness direction) and a plane direction, based on a signal applied to the first electrode layer 120 and the second electrode layer 130 by the driving circuit. For example, the first vibration layer 111 and the second vibrating layer 112 may be simultaneously driven when a signal applied in the driving circuit induces a high electric field, and the first vibration layer 111 and the second vibrating layer 112 may be displaced (or vibrated or driven) by a large deformation of the first vibration layer 111 and/or the second vibration layer 112, thereby implementing or realizing a vibration apparatus 100 in which a sound characteristic and/or a sound pressure level characteristic of a low-pitched sound band and a middle-high-pitched sound band of the vibration apparatus 100 may be enhanced.

A process of manufacturing the vibration generating part 110 according to an example embodiment of the present disclosure will be described below.

A method of manufacturing the vibration generation part 110 according to an example embodiment of the present disclosure may include a step of preparing a matrix material of the first vibration layer 111 and the second vibration layer 112, and a step of forming a piezoelectric by the matrix material of each of the first vibration layer 111 and the second vibration layer 112.

First, the step of preparing the matrix material may include a step of weighing raw materials, a step of mixing the raw materials, a step of calcining and synthesizing mixed the raw materials, a step of milling a synthesized matrix material, and a step of drying a milled matrix material.

The step of weighing raw materials may be a step of weighing a raw material based on a mole ratio to add an appropriate amount of solvent. For example, the matrix material of each of the first vibration layer 111 and the second vibration layer 112 may be represented by Formula 1 or Formula 2, but embodiments of the present disclosure are not limited thereto.

For example, the raw materials of the matrix material of the first vibration layer 111 may include Bi₂O₃, Na₂CO₃, TiO₂, K₂CO₃, BaCO₃, SrCO₃, and La₂O₅. Also, the raw materials of the matrix material of the second vibration layer 112 may include Na₂CO₃, K₂CO₃, Nb₂O₅, Sb₂O₃, CaCO₃, Bi₂O₃, Ag₂O, ZrO₂, Fe₂O₃. The step of weighing raw materials may be process which weighs the raw material on the basis of a mole ratio of a composition to synthesize, puts the weighed raw material into a nylon jar, and adds an appropriate amount of solvent (for example, ethanol). For example, a templated grain growth (TGG) may be applied to the method of manufacturing the first vibration layer 111 and the second vibration layer 112, or may not be applied thereto. For example, in the manufacturing the first vibration layer 111 and the second vibration layer 112, a seed material may be additionally added to the raw material of the matrix material when the templated grain growth (TGG) is applied. In the manufacturing the first vibration layer 111 and the second vibration layer 112, the seed material may not be added to the raw material of the matrix material when the templated grain growth (TGG) is not applied.

Subsequently, the step of mixing the raw materials may be a step of mixing and milling the weighed raw material and ethanol by a ball milling process. For example, the step of mixing and milling may be performed for 24 hours, but embodiments of the present disclosure are not limited thereto.

According to another example embodiment of the present disclosure, after the step of the mixing, the process may further include a step of drying to separate the powder mixed with a solvent. For example, the step of drying may separate the raw materials mixed and milled for 24 hours from the ball, then may put the mixed raw material into a dish, and may dry at a temperature of about 100° C., but embodiments of the present disclosure are not limited thereto. Accordingly, an example embodiment of the present disclosure may easily remove ethanol mixed with the raw material.

Subsequently, the step of calcining the raw materials may be phase-synthesizing primarily mixed raw materials. Accordingly, in an example embodiment of the present disclosure, carbonate of the raw material may be removed, and the raw material may uniformly react to form a uniform perovskite phase. For example, the step of phase-synthesizing may finely grind dried mixed raw materials, put the raw materials into an alumina crucible, calcining the raw materials for 6 hours in an electric furnace heated to 850° C., and naturally cooling the raw materials at a normal temperature, but embodiments of the present disclosure are not limited thereto. For example, a temperature increasing speed of the electric furnace may be 5° C./min, but embodiments of the present disclosure are not limited thereto.

Subsequently, the step of milling the phase-synthesized matrix material may be putting the matrix material into Nalgene bottle along with YSZ ball and a solvent (ethanol) and milling the matrix material by a ball milling process to form small particles, but embodiments of the present disclosure are not limited thereto. For example, the step of milling may be performed for 24 hours, but embodiments of the present disclosure are not limited thereto.

Subsequently, according to an example embodiment of the present disclosure, the process may further include a step of drying to separate the powder mixed with a solvent after the milling step. For example, the step of drying may put the milled matrix material into a dish and may sufficiently dry the milled matrix material at a temperature of 100° C., but embodiments of the present disclosure are not limited thereto. For example, the milled matrix material may be dry for 3 hours, but embodiments of the present disclosure are not limited thereto.

In the step of forming a piezoelectric, each of the first vibration layer 111 and the second vibration layer 112 may be manufactured as a sheet having an appropriate thickness through an individual tape casting process. The tape casting method may be a method of molding and sintering a material with a sheet having ductility (or softness). A templated grain growth (TGG) may be applied to the method of manufacturing the first vibration layer 111 and the second vibration layer 112, or may not be applied thereto. For example, in the manufacturing the first vibration layer 111 and the second vibration layer 112, the sheet of the first vibration layer 111 and the second vibration layer 112 may be molded by press-molding without using the tape casting process when the templated grain growth (TGG) is not applied, but embodiments of the present disclosure are not limited thereto. For example, in the manufacturing the first vibration layer 111 and the second vibration layer 112, the sheet of the first vibration layer 111 and the second vibration layer 112 may be molded based on a matrix material which a seed material is additionally added when the templated grain growth (TGG) is applied, but embodiments of the present disclosure are not limited thereto. For example, a sheet of the first vibration layer 111 may be formed by tape-casting a powder including a barium titanate (BT)-based relaxor ferroelectric material and a slurry including additives by the tape casting apparatus (or a blade). Also, a sheet of the second vibration layer 112 may be formed by tape-casting a powder including a potassium sodium niobate (KNN)-based piezoelectric material and a slurry including additives by the tape casting apparatus (or the blade). For example, additives of the first vibration layer 111 and the second vibration layer 112 may include a seed material for the templated grain growth (TGG).

Sheet of the first vibration layer 111 and sheet of the second vibration layer 112, individually manufactured by a tape casting process, may be stacked in a predetermined sequence. After forming and laminating the electrode layers 120 and 130 at the stacked sheets of the first vibration layer 111 and the second vibration layer 112, a binder included in the formation of the slurry is removed, and the vibration generating part 110 including the first vibration layer 111 and the second vibration layer 112 may be manufactured by simultaneous sintering.

A volume ratio of the sheet of the first vibration layer 111 and the sheet of the second vibration layer 112 may be adjusted. For example, a thickness of the sheet, a total number of the sheets and a matrix material ratio may vary depending on a characteristic of the matrix material and a characteristic of a vibration member. For example, a matrix material ratio of matrix materials of the first vibration layer 111 and the second vibration layer 112 may be 1:9 to 9:1, but embodiments of the present disclosure are not limited thereto.

According to an example embodiment of the present disclosure, since the volume ratio of the first vibration layer 111 and the second vibration layer 112 may be easily adjusted, the vibration apparatus 100 having desired sound pressure characteristics may be implemented according to required sound pressure characteristics.

The vibration apparatus 100 according to an example embodiment of the present disclosure may further include a cover member 140.

The cover member 140 may be configured to cover at least one or more of the first electrode layer 120 and the second electrode layer 130 of the vibration generating part 110. The cover member 140 may be configured to protect at least one or more of the first electrode layer 120 and the second electrode layer 130 of the vibration generating part 110.

The cover member 140 according to an example embodiment of the present disclosure may include a first cover member 140a.

The first cover member 140a may be disposed on the first electrode layer 120 of the vibration generating part 110. For example, the first cover member 140a may be configured to cover the first electrode layer 120 of the vibration generating part 110. For example, the first cover member 140a may be configured to have a size which is greater than that of the vibration generating part 110. The first cover member 140a may be configured to protect the vibration generating part 110 and the first electrode layer 120.

The first cover member 140a according to an example embodiment of the present disclosure may include an adhesive layer. For example, the first cover member 140a may include a base film and an adhesive layer which is on the base film and is connected with or coupled to the first electrode layer 120 of the vibration generating part 110. For example, the adhesive layer may include an electrical insulating material which has adhesive properties and is capable of compression and decompression.

According to another example embodiment of the present disclosure, the first cover member 140a may be connected with or coupled to the vibration generating part 110 or the first electrode layer 120 of the vibration generating part 110 by a first adhesive layer 140b. For example, the first cover member 140a may be connected with or coupled to the first electrode layer 120 of the vibration generating part 110 by a film laminating process using the first adhesive layer 140b. The first adhesive layer 140b may be configured to surround entire of the first electrode layer 120 of the vibration generating part 110 and a portion of a lateral surface of the vibration generating part 110.

The cover member 140 according to an example embodiment of the present disclosure may include a second adhesive layer 140c.

The second adhesive layer 140c may be disposed at the second electrode layer 130 of the vibration generating part 110. For example, the second adhesive layer 140c may be configured to cover the second electrode layer 130 of the vibration generating part 110. The second adhesive layer 140c may be configured to protect the vibration generating part 110 and the second electrode layer 130. The second adhesive layer 140c may be configured to surround entire of the second electrode layer 130 of the vibration generating part 110 and a portion of the lateral surface of the vibration generating part 110. For example, the second adhesive layer 140c may be a protection layer or a protection member.

The second adhesive layer 140c may be connected with or coupled to the first adhesive layer 140b at the lateral surface of the vibration generating part 110 or an edge portion (or a periphery portion) of the first cover member 140a. Therefore, the first adhesive layer 140b and the second adhesive layer 140c may be configured to surround or fully surround the vibration generating part 110. The first adhesive layer 140b and the second adhesive layer 140c may be configured to cover or surround all surfaces of the vibration generating part 110. For example, the vibration generating part 110 may be inserted (or accommodated) or buried (or embedded) into the adhesive layer including the first adhesive layer 140b and the second adhesive layer 140c.

The cover member 140 according to an example embodiment of the present disclosure may include a second cover member 140d.

The second cover member 140d may be disposed at the second electrode layer 130 of the vibration generating part 110. For example, the second cover member 140d may be configured to cover the second electrode layer 130 of the vibration generating part 110. For example, the second cover member 140d may be configured to have a size which is greater than that of the vibration generating part 110. The second cover member 140d may be configured to protect the vibration generating part 110 and the second electrode layer 130.

In the cover member 140 according to an example embodiment of the present disclosure, the first cover member 140a or the second cover member 140d may be omitted, but embodiments of the present disclosure are not limited thereto.

The first cover member 140a and the second cover member 140d according to an example embodiment of the present disclosure may include a same material or different materials. For example, each of the first cover member 140a and the second cover member 140d may be a polyimide film, a polyethylene terephthalate film, or a polyethylene naphthalate film, but embodiments of the present disclosure are not limited thereto.

The second cover member 140d may be connected with or coupled to the vibration generating part 110 or the second electrode layer 130 of the vibration generating part 110 by the second adhesive layer 140c. For example, the second cover member 140d may be connected with or coupled to the second electrode layer 130 of the vibration generating part 110 by a film laminating process using the second adhesive layer 140c.

The vibration generating part 110 may be disposed or inserted (or accommodated) between the first cover member 140a and the second cover member 140d. For example, the vibration generating part 110 may be inserted (or accommodated) or buried (or embedded) into the adhesive layer including the first adhesive layer 140b and the second adhesive layer 140c.

The first adhesive layer 140b and the second adhesive layer 140c according to an example embodiment of the present disclosure may include an electrical insulating material which has adhesive properties and is capable of compression and decompression. For example, the first adhesive layer 140b and the second adhesive layer 140c may include a same material or different materials. For example, each of the first adhesive layer 140b and the second adhesive layer 140c may include a thermos-plastic adhesive, a thermos-curable adhesive, epoxy resin, acrylic resin, silicone resin, urethane resin, a PSA (pressure sensitive adhesive), an OCA (optically cleared adhesive), or an OCR (optically cleared resin), but embodiments of the present disclosure are not limited thereto.

The first adhesive layer 140b and the second adhesive layer 140c may be provided between the first cover member 140a and the second cover member 140d to surround the vibration generating part 110. For example, one or more of the first adhesive layer 140b and the second adhesive layer 140c may be configured to surround the vibration generating part 110. For example, the second adhesive layer 140c may be provided as one body with the second cover member 140d, and thus, the second adhesive layer 140c and the second cover member 140d may be configured as one layer.

The cover member 140 may include a center portion MA and a periphery portion (or an edge portion) PA. The center portion MA of the cover member 140 may cover the vibration generating part 110. The periphery portion PA of the cover member 140 may surround the center portion MA. The center portion MA of the cover member 140 may be between adjacent periphery portions PA.

Referring to FIGS. 3 and 4, the vibration apparatus 100 may include the cover member 140. The cover member 140 may be configured to cover one or more of the first electrode layer 120 and a second electrode layer 130 of the vibration generating part 110 of the vibration apparatus 100. The vibration apparatus 100 according to an example embodiment of the present disclosure may further include a signal supply member 170.

The signal supply member 170 may be configured to supply a driving signal, supplied from the driving circuit, to the vibration generating part 110. The signal supply member 170 may be electrically connected with the vibration generating part 110. The signal supply member 170 may be electrically connected with the first electrode layer 120 and the second electrode layer 130 of the vibration generating part 110.

A portion of the signal supply member 170 may be accommodated (or inserted) between the cover member 140 and the vibration generating part 110. For example, a portion of the signal supply member 170 may be accommodated (or inserted) between the first cover member 140a and the first electrode layer 120 of the vibration generating part 110. For example, a portion of the signal supply member 170 may be accommodated (or inserted) between the first cover member 140a and the second cover member 140d.

According to an example embodiment of the present disclosure, an end portion (or a distal end portion or one side) of the signal supply member 170 may be disposed or inserted (or accommodated) between one edge portion (or one periphery portion) of the cover member 140 and the vibration generating part 110. For example, the end portion (or the distal end portion or the one side) of the signal supply member 170 may be disposed or inserted (or accommodated) between one edge portion (or one periphery portion) of the first cover member 140a and the first electrode layer 120 of the vibration generating part 110.

According to another example embodiment of the present disclosure, the end portion (or the distal end portion or the one side) of the signal supply member 170 may be disposed or inserted (or accommodated) between one edge portion (or one periphery portion) of the first cover member 140a and one edge portion (or one periphery portion) of the second cover member 140d. For example, the one edge portion (or the one periphery portion) of the first cover member 140a and the one edge portion (or the one periphery portion) of the second cover member 140d may accommodate or vertically cover the end portion (or the distal end portion or the one side) of the signal supply member 170. Therefore, the signal supply member 170 may be provided as one body with the vibration apparatus 100. For example, the signal supply member 170 may be configured with a signal cable, a flexible cable, a flexible printed circuit cable, a flexible flat cable, a single-sided flexible printed circuit, a single-sided flexible printed circuit board (PCB), a flexible multi-layer printed circuit, or a flexible multi-layer PCB, but embodiments of the present disclosure are not limited thereto.

The signal supply member 170 according to an example embodiment of the present disclosure may include a base member 171 and a plurality of signal lines 172a and 172b. For example, the signal supply member 170 may include the base member 171, a first signal line 172a, and a second signal line 172b.

The base member 171 may include a transparent or opaque plastic material, but embodiments of the present disclosure are not limited thereto. The base member 171 may have a certain width in a first direction X and may extend long in a second direction Y intersecting with the first direction X.

The first and second signal lines 172a and 172b may be disposed at a first surface (or an upper surface) of the base member 171 in parallel to the second direction Y and may be spaced apart from or electrically disconnected from each other in the first direction X. The first and second signal lines 172a and 172b may be disposed at the first surface of the base member 171 in parallel. For example, the first and second signal lines 172a and 172b may be implemented in a line shape, based on patterning of a metal layer (or a conductive layer) which is formed or deposited on the first surface of the base member 171.

End portions (or distal end portions or one sides) of the first and second signal lines 172a and 172b may be spaced apart from each other, and thus, may be individually curved or bent.

The end portion (or the distal end portion or the one side) of the first signal line 172a may be electrically connected with the first electrode layer 120 of the vibration generating part 110. For example, the end portion of the first signal line 172a may be electrically connected with at least a portion of the first electrode layer 120 of the vibration generating part 110 at one edge portion (or one periphery portion) of the first cover member 140a. For example, the end portion (or the distal end portion or the one side) of the first signal line 172a may be electrically and directly connected with at least a portion of the first electrode layer 120 of the vibration generating part 110. For example, the end portion (or the distal end portion or the one side) of the first signal line 172a may be directly connected with or directly contact the first electrode layer 120 of the vibration generating part 110. For example, the end portion of the first signal line 172a may be electrically connected with the first electrode layer 120 by a conductive double-sided tape. Accordingly, the first signal line 172a may supply a first driving signal, supplied from a vibration driver, to the first electrode layer 120 of the vibration generating part 110.

The end portion (or the distal end portion or the one side) of the second signal line 172b may be electrically connected with the second electrode layer 130 of the vibration generating part 110. For example, the end portion of the second signal line 172b may be electrically connected with at least a portion of the second electrode layer 130 of the vibration generating part 110 at one edge portion (or one periphery portion) of the second cover member 140d. For example, the end portion (or the distal end portion or the one side) of the second signal line 172b may be electrically and directly connected with at least a portion of the second electrode layer 130 of the vibration generating part 110. For example, the end portion (or the distal end portion or the one side) of the second signal line 172b may be directly connected with or directly contact the second electrode layer 130 of the vibration generating part 110. For example, the end portion of the second signal line 172b may be electrically connected with the second electrode layer 130 by a conductive double-sided tape. Accordingly, the second signal line 172b may supply a first driving signal, supplied from a vibration driver, to the second electrode layer 130 of the vibration generating part 110.

The signal supply member 170 according to an example embodiment of the present disclosure may further include an insulation layer 173.

The insulation layer 173 may be disposed at the first surface (or an upper surface) of the base member 171 to cover each of the first signal line 172a and the second signal line 172b except the end portion (or the one side) of the signal supply member 170.

According to an example embodiment of the present disclosure, an end portion (or one side) 173a of the insulation layer 173 and the end portion (or the one side) of the signal supply member 170 including the end portion (or the one side) of the base member 171 may be inserted (or accommodated) between the cover member 140 and the vibration generating part 110 and may be fixed between the cover member 140 and the vibration generating part 110 by the first adhesive layer 140b and the second adhesive layer 140c.

According to another example embodiment of the present disclosure, the end portion (or the one side) 173a of the insulation layer 173 and the end portion (or the one side) of the signal supply member 170 including the end portion (or the one side) of the base member 171 may be inserted (or accommodated) between the first cover member 140a and the second cover member 140d and may be fixed between the first cover member 140a and the second cover member 140d by the first adhesive layer 140b and the second adhesive layer 140c. Therefore, an end portion (or one side) of the first signal line 172a may be maintained with being electrically connected with the first electrode layer 120 of the vibration generating part 110, and an end portion (or one side) of the second signal line 172b may be maintained with being electrically connected with the second electrode layer 130 of the vibration generating part 110. Also, the end portion (or the one side) of the signal supply member 170 may be inserted (or accommodated) between the first cover member 140a and the vibration generating part 110, and thus, may prevent the occurrence of a connection defect between the vibration apparatus 100 and the signal supply member 170 caused by the movement of the signal supply member 170 in a process of inserting (or accommodating) the signal supply member 170 into a region between adjacent vibration apparatuses 100.

In the signal supply member 170 according to an example embodiment of the present disclosure, each of the end portion (or the one side) of the base member 171 and the end portion (or the one side) 173a of the insulation layer 173 may be removed. For example, each of the end portion of the first signal line 172a and the end portion of the second signal line 172b may not be supported or covered by each of the end portion (or the one side) of the base member 171 and the end portion (or the one side) 173a of the insulation layer 173 and may be exposed at the outside. For example, the end portion of each of the first and second signal lines 172a and 172b may protrude (or extend) to have a certain length from an end 171e of the base member 171 or an end 173e of the insulation layer 173. Accordingly, each of the end portion (or the distal end portion or the one side) of each of the first and second signal lines 172a and 172b may be individually or independently bent.

The end portion (or the one side) of the first signal line 172a, which is not supported by each of the end portion (or the one side) of the base member 171 and the end portion (or the one side) 173a of the insulation layer 173, may be directly connected with or directly contact the first electrode layer 120 of the vibration generating part 110. The end portion (or the one side) of the second signal line 172b, which is not supported by each of the end portion (or the one side) of the base member 171 and the end portion (or the one side) 173a of the insulation layer 173, may be directly connected with or directly contact the second electrode layer 130 of the vibration generating part 110.

According to an example embodiment of the present disclosure, a portion of the signal supply member 170 or a portion of the base member 171 may be disposed or inserted (or accommodated) between the cover member 140 and the vibration generating part 110, and thus, the signal supply member 170 may be provided as one body with the vibration apparatus 100. For example, a portion of the signal supply member 170 or a portion of the base member 171 may be disposed or inserted (or accommodated) between the first cover member 140a and the second cover member 140d, and thus, the signal supply member 170 may be provided as one body with the vibration apparatus 100. Accordingly, the vibration apparatus 100 and the signal supply member 170 may be configured as one part (or one component), and thus, an effect of uni-materialization may be realized.

According to an example embodiment of the present disclosure, because the first signal line 172a and the second signal line 172b of the signal supply member 170 are provided as one body with the vibration apparatus 100, a soldering process for an electrical connection between the vibration apparatus 100 and the signal supply member 170 may not be needed, and thus, a manufacturing process and a structure of the vibration apparatus 100 may be simplified, thereby decreasing a harmful process.

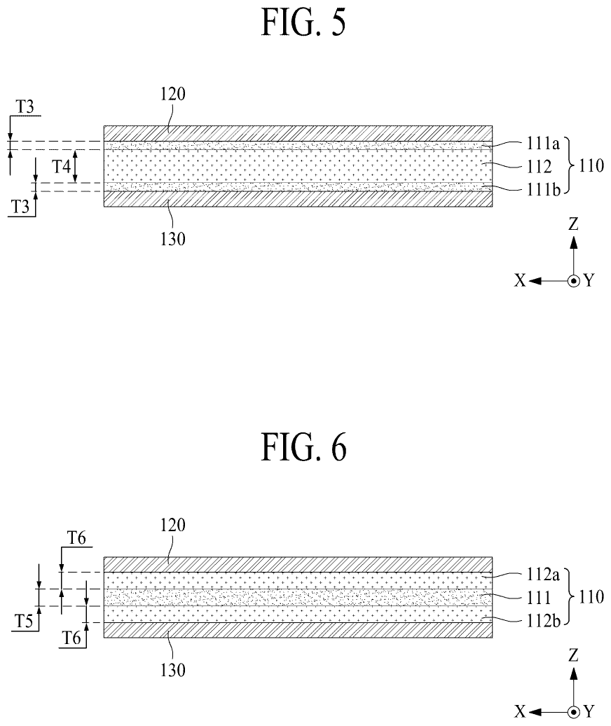

FIGS. 5 to 8 illustrate a vibration apparatus according to another example embodiment of the present disclosure. FIGS. 5 to 8 illustrate another embodiment of the vibration generating part 110 described above with reference to FIGS. 1 to 4. Therefore, in the following description, repeated descriptions of the other elements except a vibration generating part 110 are omitted or will be briefly given.

Referring to FIG. 5, a vibration generating part 110 according to another example embodiment of the present disclosure may include a plurality of first vibration layers 111a and 111b and at least one second vibration layer 112.

The plurality of first vibration layers 111a and 111b and the at least one second vibration layer 112 may have different thicknesses from each other. For example, the plurality of first vibration layers 111a and 111b and the at least one second vibration layer 112 may have different volumes from each other.

The plurality of first vibration layers 111a and 111b may include a 1-1 vibration layer 111a and a 1-2 vibration layer 111b. The at least one second vibration layer 112 may be disposed or configured between the 1-1 vibration layer 111a and the 1-2 vibration layer 111b. Each of the 1-1 vibration layer 111a and the 1-2 vibration layer 111b may be configured to have a thickness thinner than that of the second vibrating layer 112. For example, each of the 1-1 vibration layer 111a and the 1-2 vibration layer 111b may be configured to have a third thickness T3, and the second vibration layer 112 may be configured to have a fourth thickness T4 greater than the third thickness T3. For example, the third thickness T3 of each of plurality of first vibration layers 111a and 111b may be a thickness which is equal to or thinner than ½ of the fourth thickness T4 of the second vibration layer 112. Therefore, the plurality of first vibration layers 111a and 111b may be configured to have a volume which is equal to or smaller than the second vibration layer 112. For example, the plurality of first vibration layers 111a and 111b may be composed of a volume of 40 vol % or less based on a total volume including the plurality of first vibration layers 111a and 111b and the at least one second vibration layer 112. Accordingly, since the plurality of first vibration layers 111a and 111b according to another example embodiment of the present disclosure may be configured to have a thickness thinner than the second vibration layer 112, and the plurality of first vibration layers 111a and 111b may be induced a higher applied electric field than the second vibrating layer 112. As a result, the plurality of first vibration layers 111a and 111b and the second vibration layer 112 may be simultaneously driven, thereby implementing or realizing the large deformation characteristics of the plurality of first vibration layers 111a and 111b and the second vibration layer 112.

Referring to FIG. 6, a vibration generating part 110 according to another example embodiment of the present disclosure may include at least one first vibration layer 111 and a plurality of second vibration layers 112a and 112b.

The at least one first vibration layers 111 and the plurality of second vibration layers 112a and 112b may have different thicknesses from each other. For example, the at least one first vibration layers 111 and the plurality of second vibration layers 112a and 112b may have different volumes from each other.

The plurality of second vibration layers 112a and 112b may include a 2-1 vibration layer 112a and a 2-2 vibration layer 112b. The at least one first vibration layer 111 may be disposed or configured between the 2-1 vibration layer 112a and the 2-2 vibration layer 112b. The at least one first vibration layer 111 may be configured to have a thickness thinner than that of the plurality of second vibration layers 112a and 112b. For example, the at least one first vibration layer 111 may be configured to have a fifth thickness T5, and each of the plurality of second vibration layers 112a and 112b may be configured to have a sixth thickness T6 that is equal to or different from the fifth thickness T5. For example, the fifth thickness T5 of the at least one first vibration layer 111 may be equal to, thinner than or greater than the sixth thickness T6 of each of the plurality of second vibration layers 112a and 112b, and may be thinner than twice of the sixth thickness T6. Therefore, the at least one first vibration layer 111 may be configured to have a volume which is equal to or smaller than the plurality of second vibration layers 112a and 112b. For example, the at least one first vibration layer 111 may be composed of a volume of 40 vol % or less based on a total volume including the at least one first vibration layer 111 and the plurality of second vibration layers 112a and 112b. Accordingly, since the at least one first vibration layer 111 according to another example embodiment of the present disclosure may be configured to have a thickness thinner than the plurality of second vibration layers 112a and 112b, and the at least one first vibration layer 111 may be induced a higher applied electric field than the plurality of second vibration layers 112a and 112b. As a result, the at least one first vibration layer 111 and the plurality of second vibration layers 112a and 112b may be simultaneously driven, thereby implementing or realizing the large deformation characteristics of the at least one first vibration layer 111 and the plurality of second vibration layers 112a and 112b.

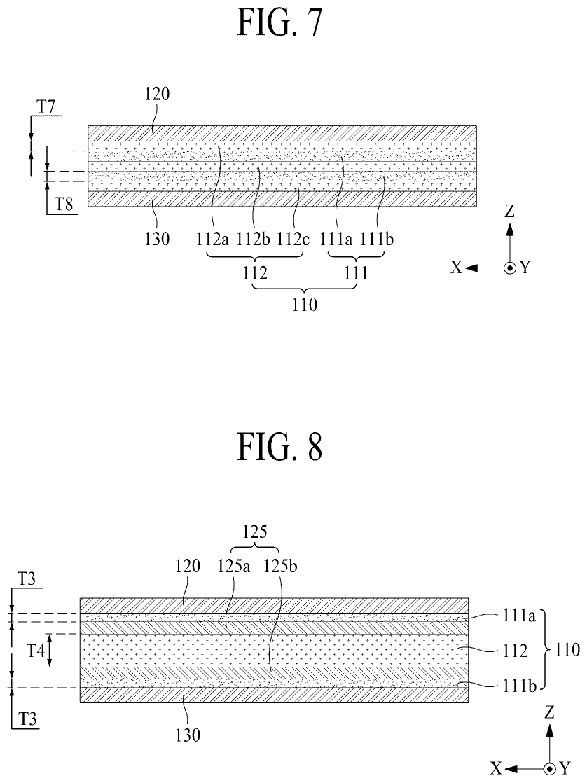

Referring to FIG. 7, a vibration generating part 110 according to another example embodiment of the present disclosure may include a plurality of first vibration layers 111a and 111b and a plurality of second vibration layers 112a to 112c.

The plurality of first vibration layers 111a and 111b and the plurality of second vibration layers 112a to 112c may have different thicknesses from each other. For example, the plurality of first vibration layers 111a and 111b and the plurality of second vibration layers 112a to 112c may have different volumes from each other.

The plurality of first vibration layers 111a and 111b may include a 1-1 vibration layer 111a and a 1-2 vibration layer 111b. The plurality of second vibration layers 112a to 112c may include a 2-1 vibration layer 112a, a 2-2 vibration layer 112b, and a 2-3 vibration layer 112c. The plurality of first vibration layers 111a and 111b and the plurality of second vibration layers 112a to 112c may be disposed or configured to alternately stacked with each other. For example, the 1-2 vibration layer 111b of the plurality of first vibration layers 111a and 111b may be disposed or configured between the 2-2 vibration layer 112b and the 2-3 vibration layer 112c of the plurality of second vibration layers 112a to 112c. Each of the plurality of first vibration layers 111a and 111b and the plurality of second vibration layers 112a to 112c may be configured to have thicknesses which is equal to or different from each other. For example, each of the plurality of second vibration layers 112a to 112c may be configured to have a seventh thickness T7, each of the plurality of first vibration layers 111a and 111b may be configured to have an eighth thickness T8 that is equal to or different from the seventh thickness T7. The seventh thickness T7 and the eighth thickness T8 of each of the plurality of first vibration layers 111a and 111b and the plurality of second vibration layers 112a to 112c may have equal thicknesses. The plurality of first vibration layers 111a and 111b may be composed of a same number or less than the plurality of second vibration layers 112a to 112c. Therefore, the plurality of first vibration layers 111a and 111b may be configured to have a volume which is equal to or smaller than the plurality of second vibration layers 112a to 112c. For example, the plurality of first vibration layers 111a and 111b may be composed of a volume of 40 vol % or less based on a total volume including the plurality of first vibration layers 111a and 111b and the plurality of second vibration layers 112a to 112c. Accordingly, since the plurality of first vibration layers 111a and 111b according to another example embodiment of the present disclosure may be configured to have a thickness thinner than the plurality of second vibration layers 112a to 112c, and the plurality of first vibration layers 111a and 111b may be induced a higher applied electric field than the plurality of second vibration layers 112a to 112c. As a result, the plurality of first vibration layers 111a and 111b and the plurality of second vibration layers 112a to 112c may be simultaneously driven, thereby implementing or realizing the large deformation characteristics of the plurality of first vibration layers 111a and 111b and the plurality of second vibration layers 112a to 112c.

Referring to FIG. 8, a vibration generating part 110 according to another example embodiment of the present disclosure may further include a middle electrode layer 125. The vibration generating part 110 may include a plurality of first vibration layers 111a and 111b and at least one second vibration layer 112.

The middle electrode layer 125 may be disposed or configured between the plurality of first vibration layers 111a and 111b and the at least one second vibration layer 112. For example, the middle electrode layer 125 may be provided as one or more, and the one or more middle electrode layer 125 may include a first middle electrode layer 125a and a second middle electrode layer 125b. For example, the first middle electrode layer 125a may be disposed or configured between the 1-1 vibration layer 111a of the plurality of first vibration layers 111a and 111b and the second vibration layer 112. The second middle electrode layer 125b may be disposed or configured between the 1-2 vibration layer 111b of the plurality of first vibration layers 111a and 111b and the second vibration layer 112.

Each of the 1-1 vibration layer 111a between the first electrode layer 120 and the first middle electrode layer 125a and the 1-2 vibration layer 111b between the second electrode layer 130 and the second middle electrode layer 125b may be configured to have the third thickness T3. The second vibration layer 112 between the first middle electrode layer 125a and the second middle electrode layer 125b may be configured to have the fourth thickness T4 that is greater than the third thickness T3. Therefore, an electric field applied to each of the plurality of the first vibration layers 111a and 111b may be induced to a higher electric field than an electric field applied to the at least one second vibration layer 112. Accordingly, the plurality of first vibration layers 111a and 111b according to another example embodiment of the present disclosure may be configured be induced a higher applied electric field than the second vibrating layer 112. As a result, the plurality of first vibration layers 111a and 111b and the second vibration layer 112 may be simultaneously driven, thereby implementing or realizing the large deformation characteristics of the plurality of first vibration layers 111a and 111b and the second vibration layer 112.

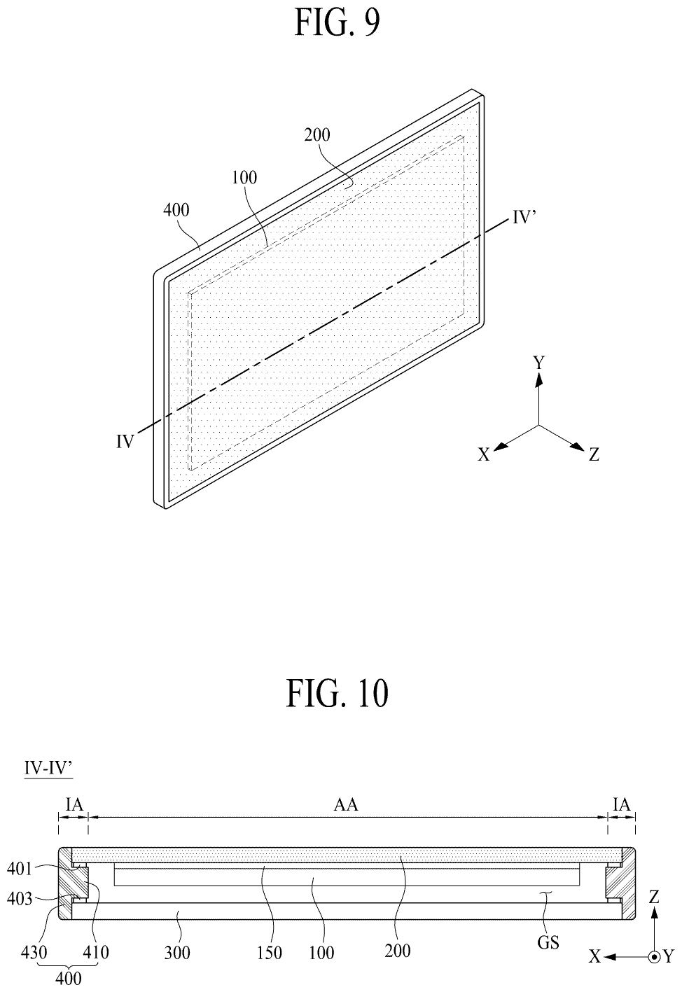

FIG. 9 illustrates an apparatus according to an example embodiment of the present disclosure. FIG. 10 is a cross-sectional view taken along line IV-IV′ illustrated in FIG. 9 according to an example embodiment of the present disclosure.

Referring to FIGS. 9 and 10, an apparatus according to an example embodiment of the present disclosure may be implemented or provided as a sound apparatus, a sound output apparatus, a vibration apparatus, a vibration generating apparatus, a sound bar, a sound system, a sound apparatus for electronic apparatuses, a sound apparatus for display apparatuses, a sound apparatus for vehicular apparatus, or a sound bar for vehicular apparatus. For example, the vehicular apparatus or the transporting apparatus may include one or more of seat and one or more of window. For example, the vehicular apparatus or the transporting apparatus may include a vehicle, a train, a ship, or an aircraft, but embodiments of the present disclosure are not limited thereto. The apparatus according to an example embodiment of the present disclosure may be implemented or provided as a signage panel such as an analog signage or digital signage such as an advertisement signboard, a poster, and a guide board.

The apparatus according to an example embodiment of the present disclosure may be a display apparatus which includes a plurality of pixels, but embodiments of the present disclosure are not limited thereto.

The display apparatus may include a display panel, including a plurality of pixels implementing a black and white, or color image, and a driver for driving the display panel. Each of the plurality of pixels may be a subpixel configuring one of a plurality of colors implementing a color image. An apparatus according to an example embodiment of the present disclosure may include a notebook computer, a television (TV), a computer monitor, an equipment apparatus including a specific form of a vehicle or a vehicular or automotive apparatus, and a set device (or a set apparatus) or a set electronic apparatus such as a smartphone or an electronic pad, which are complete products (or final products) including a display panel such as a liquid crystal display panel or an organic light emitting display panel.

Referring to FIG. 9, the apparatus according to an example embodiment of the present disclosure may include a vibration apparatus 100 and a vibration member 200.

The vibration member 200 may generate or output a vibration (or a sound wave), based on a displacement (or driving) of the vibration apparatus 100. The vibration member 200 may be a vibration object, a display member, a display panel, a signage panel, a passive vibration member, a passive vibration plate, a front member, a rear member, a vibration panel, a sound panel, a passive vibration panel, a sound output plate, a sound vibration plate, or an image screen, but embodiments of the present disclosure are not limited thereto.

For example, the vibration member 200 may include one or more of a display panel including a pixel configured to display an image, a screen panel on which an image is to be projected from a display apparatus, a lighting panel, a signage panel, a vehicular interior material, a vehicular glass window, a vehicular exterior material, a ceiling material of a building, an interior material of a building, a glass window of a building, an interior material of an aircraft, and a glass window of an aircraft. For example, the vibration member 200 may include one or more materials among wood, plastic, glass, metal, cloth, fiber, paper, rubber, leather, carbon, and mirror.

Hereinafter, an example where the vibration member 200 is a display panel will be described.

Referring to FIGS. 9 and 10, the display panel 200 may display an image, and for example, may display an image (for example, an electronic image, a digital image, a still image, or a video image). For example, the display panel 200 may emit light to display an image. The display panel 200 may be a curved display panel or all types of display panels such as a liquid crystal display panel, an organic light emitting display panel, a quantum dot light emitting display panel, a micro light emitting diode display panel, and an electrophoresis display panel. The display panel 200 may be a flexible display panel. For example, the display panel 200 may be a flexible light emitting display panel, a flexible electrophoresis display panel, a flexible electro-wetting display panel, a flexible micro light emitting diode display panel, or a flexible quantum dot light emitting display panel, but embodiments of the present disclosure are not limited thereto.

The display panel 200 according to an example embodiment of the present disclosure may include a display area AA which displays an image on the basis of driving of a plurality of pixels. Also, the display panel 200 may further include a non-display area IA which surrounds the display area AA, but embodiments of the present disclosure are not limited thereto. For example, the non-display area IA may be around the display area AA.

The vibration apparatus 100 may be configured to vibrate the display panel 200. For example, the vibration apparatus 100 may vibrate the display panel 200 at a rear surface of the display panel 200, and thus, may provide a user with a sound and/or a haptic feedback on the basis of a vibration of the display panel 200. The vibration apparatus 100 may be implemented at the rear surface of the display panel 200 to directly vibrate the display panel 200.

According to an example embodiment of the present disclosure, the vibration apparatus 100 may vibrate based on a vibration driving signal synchronized with an image displayed by the display panel 200, thereby vibrating the display panel 200. According to another example embodiment of the present disclosure, the vibration apparatus 100 may vibrate based on a haptic feedback signal (or a tactile feedback signal) synchronized with a user touch applied to a touch panel (or a touch sensor layer) which is disposed on the display panel 200 or embedded in the display panel 200, and thus, may vibrate the display panel 200. Accordingly, the display panel 200 may vibrate based on a vibration of the vibration apparatus 100 to provide a user (or a viewer) with one or more of a sound and a haptic feedback.

The vibration apparatus 100 according to an example embodiment of the present disclosure may be implemented to have a size corresponding to the display area AA of the display panel 200. A size of the vibration apparatus 100 may be 0.9 to 1.1 times a size of the display area AA of the display panel 200, but embodiments of the present disclosure are not limited thereto. For example, a size of the vibration apparatus 100 may be less than or equal to that of the display area AA. For example, a size of the vibration apparatus 100 may be equal to or almost equal to that of the display area AA of the display panel 200, and thus, may cover a large region of the display panel 200 or an entire region of the display panel 200 and a vibration generated by the vibration apparatus 100 may vibrate a whole region of the display panel 200, thereby enhancing satisfaction of a user and increasing a sense of localization of a sound. Also, a contact area (or a panel coverage) between the display panel 200 and the vibration apparatus 100 may increase, and thus, a vibration region of the display panel 200 may increase, thereby enhancing a sound of a middle-low pitched sound band generated based on a vibration of the display panel 200. Also, the vibration apparatus 100 applied to a large-sized apparatus may vibrate all of the display panel 200 having a large size (or a large area), and thus, a sense of orientation of a sound based on a vibration of the display panel 200 may be more enhanced, thereby realizing an enhanced sound effect. Accordingly, the vibration apparatus 100 according to an example embodiment of the present disclosure may be disposed at the rear surface of the display panel 200 to sufficiently vibrate the display panel 200 in a vertical (or forward and rearward) direction, thereby outputting a desired sound in a forward direction of the apparatus or the display apparatus.

The vibration apparatus 100 according to an example embodiment of the present disclosure may be implemented as a film type. Because the vibration apparatus 100 is implemented as a film type, the vibration apparatus 100 may have a thickness which is thinner than the display panel 200, thereby minimizing an increase in thickness of the apparatus caused by the arrangement of the vibration apparatus 100. For example, the vibration apparatus 100 may be referred to as a sound generating module, a vibration generating apparatus, a film actuator, a film type piezoelectric composite actuator, a film speaker, a film type piezoelectric speaker, or a film type piezoelectric composite speaker, which uses the display panel 200 as a sound vibration plate, but embodiments of the present disclosure are not limited thereto. For example, the vibration apparatus 100 may be substantially the same as the vibration apparatus 100 described above with reference to FIGS. 1 to 8, and thus, repeated descriptions thereof are omitted.

In another embodiment of the present disclosure, the vibration apparatus 100 need not be disposed at the rear surface of the display panel 200 and may be applied to a vibration object instead of the display panel 200. For example, the vibration object may be a non-display panel, a mirror, an interior material of a vehicle, a glass window of a vehicle, an indoor ceiling of a building, a glass window of a building, an interior material of an aircraft, or a glass window of an aircraft, but embodiments of the present disclosure are not limited thereto. For example, the vibration object may be a sound panel or a sound plate including one or more materials of wood, metal, plastic, glass, cloth, paper, fiber, rubber, leather, and carbon, but embodiments of the present disclosure are not limited thereto. For example, the non-display panel may be a light emitting diode lighting panel (or apparatus), an organic light emitting lighting panel (or apparatus), or an inorganic light emitting lighting panel (or apparatus), but embodiments of the present disclosure are not limited thereto. In this case, a vibration object may be applied as a vibration plate, and the vibration apparatus 100 may vibrate the vibration object to output a sound.

Referring to FIG. 10, the apparatus according to an example embodiment of the present disclosure may include a connection member 150 between the vibration apparatus 100 and the display panel 200.

The connection member 150 may include at least one base member and may include an adhesive layer attached on one surface or both surfaces of the base member, or may be configured as a single-layered adhesive layer.

According to an example embodiment of the present disclosure, the connection member 150 may include a foam pad, a double-sided tape, a double-sided foam tape, or an adhesive, but embodiments of the present disclosure are not limited thereto. For example, the adhesive layer of the connection member 150 may include epoxy, acryl, silicone, or urethane, but embodiments of the present disclosure are not limited thereto.

The apparatus according to an example embodiment of the present disclosure may further include a supporting member 300 which is disposed at the rear surface of the display panel 200.

The supporting member 300 may cover the rear surface of the display panel 200. For example, the supporting member 300 may cover the whole rear surface of the display panel 200 with a gap space GS therebetween. For example, the supporting member 300 may include one or more of a glass material, a metal material, and a plastic material. For example, the supporting member 300 may be a rear structure or a set structure. For example, the supporting member 300 may be referred to as the other term such as a cover bottom, a plate bottom, a back cover, a base frame, a metal frame, a metal chassis, a chassis base, or an m-chassis. Therefore, the supporting member 300 may be implemented as an arbitrary type frame or a plate structure disposed on the rear surface of the display panel 200.

The apparatus according to an example embodiment of the present disclosure may further include a middle frame 400.

The middle frame 400 may be disposed between a rear edge (or a rear periphery) of the display panel 200 and a front edge portion (or a front periphery portion) of the supporting member 300. The middle frame 400 may support each of one or more of an edge portion (or a periphery portion) of the display panel 200 and an edge portion (or a periphery portion) of the supporting member 300 and may surround one or more of lateral surfaces of each of the display panel 200 and the supporting member 300. The middle frame 400 may provide a gap space GS between the display panel 200 and the supporting member 300. The middle frame 400 may be referred to as a middle cabinet, a middle cover, or a middle chassis, but embodiments of the present disclosure are not limited thereto.

The middle frame 400 according to an example embodiment of the present disclosure may include a first supporting portion 410 and a second supporting portion 430.

The first supporting portion 410 may be disposed between the rear edge (or the rear periphery) of the display panel 200 and the front edge (or the front periphery) of the supporting member 300, and thus, may provide the gap space GS between the display panel 200 and the supporting member 300. A front surface of the first supporting portion 410 may be coupled to or connected with the rear edge portion (or the rear periphery portion) of the display panel 200 by a first frame connection member 401. A rear surface of the first supporting portion 410 may be coupled to or connected with a front edge portion (or a front periphery portion) of the supporting member 300 by a second frame connection member 403. For example, the first supporting portion 410 may have a single picture frame structure having a tetragonal shape, or may include a picture frame structure having a plurality of division bar shapes. But embodiments of the present disclosure are not limited thereto.

The second supporting portion 430 may be vertically coupled to an outer surface of the first supporting portion 410 in parallel with a thickness direction Z of an apparatus. The second supporting portion 430 may surround one or more of an outer surface of the display panel 200 and an outer surface of the supporting member 300, and thus, may protect the outer surface of each of the display panel 200 and the supporting member 300. The first supporting portion 410 may protrude toward the gap space GS between the display panel 200 and the supporting member 300 from an inner surface of the second supporting portion 430.

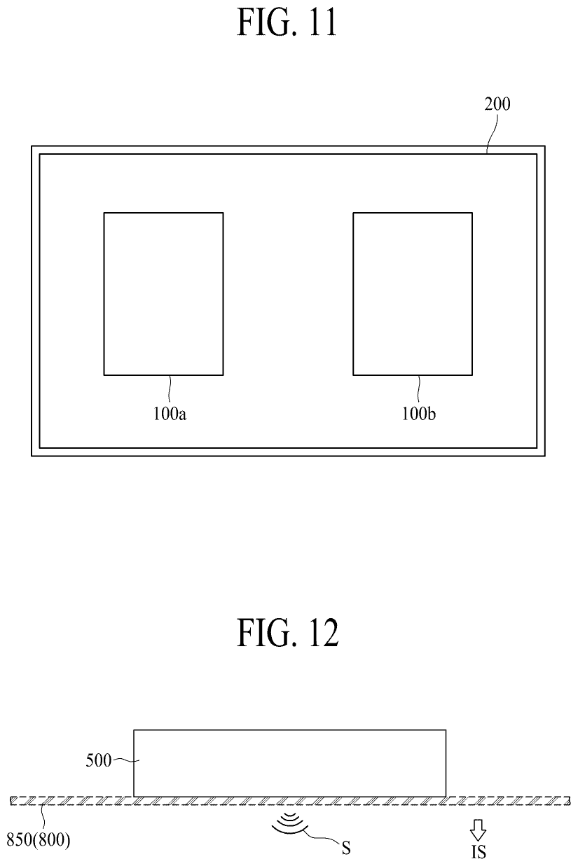

FIG. 11 is a plan view of an apparatus including a vibration apparatus according to another example embodiment of the present disclosure.

Referring to FIG. 11, each of one or more vibration apparatuses 100a and 100b may be substantially the same as the vibration apparatus 100 described above with reference to FIGS. 1 to 8, and thus, repeated descriptions thereof are omitted. According to an example embodiment of the present disclosure, an apparatus 200 (or the vibration member or the display panel) may be connected with one or more vibration apparatuses 100a and 100b. Therefore, the apparatus 200 may be connected with one or more vibration apparatuses 100a and 100b, and thus, may output a sound and/or a vibration (or a haptic vibration) based on vibrations of the one or more vibration apparatuses 100a and 100b.

According to an example embodiment of the present disclosure, the one or more vibration apparatuses 100a and 100b may provide a visual function, an acoustic function, and a multifunction (or visual sense or acoustic sense), based on the control of a driving frequency.

FIG. 12 illustrates a vibration apparatus for a vehicle according to another example embodiment of the present disclosure.

Referring to FIG. 12, a vehicular vibration apparatus according to an example embodiment of the present disclosure may include a vibration apparatus 500. The vibration apparatus 500 may be substantially the same as the vibration apparatus 100 described above with reference to FIGS. 1 to 8, and thus, repeated descriptions thereof are omitted.

The vibration apparatus 500 may be disposed or equipped in a vehicle so as to output a sound S toward an internal space IS of a vehicle 800.

The vehicle 800 may include an interior material (or an interior finish material) 850. In the following description, for convenience of description, the “interior material 850” may be referred to as a “vehicular interior material 850”.

The vehicular interior material 850 may include all parts configuring the inside of the vehicle 800, or may include all parts disposed at the internal space IS of the vehicle 800. For example, the vehicular interior material 850 may be an interior member or an inner finishing member of the vehicle 800, but embodiments of the present disclosure are not limited thereto.

The vehicular interior material 850 according to an example embodiment of the present disclosure may be configured to be exposed at the internal or indoor space IS of the vehicle 800. For example, the vehicular interior material 850 may be provided to cover one surface (or an interior surface) of at least one of a main frame (or a vehicular body), a side frame (or a side body), a door frame (or a door body), a handle frame (or a steering hub), and a seat frame, which are exposed at the indoor space IS of the vehicle 800.

The vehicular interior material 850 according to an example embodiment of the present disclosure may include a dash board, a pillar interior material (or a pillar trim), a floor interior material (or a floor carpet), a roof interior material (or a headliner), a door interior material (or a door trim), a handle interior material (or a steering cover), a seat interior material, a rear package interior material (or a backseat shelf), an overhead console (or an indoor illumination interior material), a rear view mirror, a glove box, and a sun visor, but embodiments of the present disclosure are not limited thereto.

The vehicular interior material 850 according to an example embodiment of the present disclosure may include one or more of metal, wood, rubber, plastic, glass, fiber, cloth, paper, mirror, leather, and carbon, but embodiments of the present disclosure are not limited thereto. The vehicular interior material 850 including a plastic material may be an injection material which is implemented by an injection process using thermosetting resin or thermoplastic resin, but embodiments of the present disclosure are not limited thereto. The vehicular interior material 850 including a fiber material may include one or more of synthetic fiber, carbon fiber (or aramid fiber), and natural fiber, but embodiments of the present disclosure are not limited thereto. The vehicular interior material 850 including a fiber material may include may be a fabric sheet, a knitting sheet, or a nonwoven fabric, but embodiments of the present disclosure are not limited thereto. For example, the paper may be cone paper. For example, the cone paper may be pulp or foam plastic, but embodiments of the present disclosure are not limited thereto. The vehicular interior material 850 including a leather material may include may be a natural leather or an artificial leather, but embodiments of the present disclosure are not limited thereto.

The vehicular interior material 850 according to an example embodiment of the present disclosure may include one or more of a flat part and a curved part. For example, the vehicular interior material 850 may have a structure corresponding to a structure of a corresponding vehicular structure, or may have a structure which differs from the structure of the corresponding vehicular structure.

According to an example embodiment of the present disclosure, the vibration apparatus 500 may be disposed at the vehicular interior material 850. The vibration apparatus 500 may vibrate the vehicular interior material 850 to generate a sound S, based on a vibration of the vehicular interior material 850. For example, the vibration apparatus 500 may directly vibrate the vehicular interior material 850 to generate the sound S, based on a vibration of the vehicular interior material 850.

For example, the vibration apparatus 500 may be configured to vibrate the vehicular interior material 850 to output the sound S toward the internal or indoor space IS of the vehicle 800. Therefore, the vehicular interior material 850 may be used as a sound vibration plate. The vehicular interior material 850 may be a vibration plate, a sound vibration plate, or a sound generating plate for outputting the sound S. For example, the vehicular interior material 850 may have a size which is greater than that of the vibration apparatus 500, but embodiments of the present disclosure are not limited thereto.

For example, the vibration apparatus 500 may be disposed at one or more of a dash board, a pillar interior material, a floor interior material, a roof interior material, a door interior material, a handle interior material, and a seat interior material, or may be disposed in one or more of a rear package interior material, an overhead console, a rear view mirror, a glove box, and a sun visor.

The vibration apparatus 500 according to an example embodiment of the present disclosure may vibrate a correspond vehicular interior material 850 through at least one of one or more vibration apparatus 500 disposed at the vehicular interior material 850 to output a realistic sound S and/or stereo sound, including a multichannel, toward the indoor space IS of the vehicle 800.

A vibration apparatus and an apparatus including the same according to various example embodiments of the present disclosure will be described below. These are provided as examples, and do not limit the scope of the present disclosure.

A vibration apparatus according to various example embodiments of the present disclosure may include a first electrode layer, a second electrode layer, and a first vibration layer and a second vibration layer between the first electrode layer and the second electrode layer, the first vibration layer and the second vibration layer having different deformation characteristics from each other.

According to various example embodiments of the present disclosure, the different deformation characteristics may include a phase transition deformation characteristic and an electric field induced deformation characteristic.

According to various example embodiments of the present disclosure, the first vibration layer and the second vibration layer may be stacked to overlap each other.

According to various example embodiments of the present disclosure, the first vibration layer and the second vibration layer may have different thicknesses from each other.

According to various example embodiments of the present disclosure, the first vibration layer may have a thickness which is thinner than a thickness of the second vibration layer.

According to various example embodiments of the present disclosure, the first vibration layer and the second vibration layer may have different volumes from each other.

According to various example embodiments of the present disclosure, the first vibration layer may have a volume which is smaller than a volume of the second vibration layer.

According to various example embodiments of the present disclosure, the first vibration layer may be composed of a volume of 40 vol % or less but greater than 0 vol % based on a total volume including the first vibration layer and the second vibration layer.

According to various example embodiments of the present disclosure, the first vibration layer may include a relaxor ferroelectric material, and the second vibration layer may include a ferroelectric material or a piezoelectric material.

According to various example embodiments of the present disclosure, the first vibration layer may include a bismuth (Bi)-based material.

According to various example embodiments of the present disclosure, the second vibration layer may include at least one of a lead zirconate titanate (PZT)-based material, a potassium sodium niobate (KNN)-based material, and a barium titanate (BT)-based material.

According to various example embodiments of the present disclosure, the first vibration layer may include a plurality of first vibration layers, and the second vibration layer may be between the plurality of first vibration layers and may have a thickness greater than that of each of the plurality of first vibration layers.

According to various example embodiments of the present disclosure, the second vibration layer may include a plurality of second vibration layers, and the first vibration layer may be between the plurality of second vibration layers and may have a thickness thinner than that of each of the plurality of second vibration layers.

According to various example embodiments of the present disclosure, the first vibration layer may include a plurality of first vibration layers, the second vibration layer may include a plurality of second vibration layers, and the plurality of first vibration layers may have a thickness which is equal to or thinner than a thickness of the plurality of second vibration layers, and the plurality of first vibration layers may be composed of a same number or less than that of the plurality of second vibration layers.

According to various example embodiments of the present disclosure, the vibration apparatus may further include a middle electrode layer disposed between the first vibration layer and the second vibration layer.

According to various example embodiments of the present disclosure, the vibration apparatus may further include a signal supply member configured to supply a driving signal, supplied from a driving circuit, to the first electrode layer and the second electrode layer.

According to various example embodiments of the present disclosure, the signal supply member may comprise a base member and a plurality of signal lines.

According to various example embodiments of the present disclosure, ends of the plurality of signal lines may be connected with the respective first electrode layer and second electrode layer.

An apparatus according to various example embodiments of the present disclosure may include a vibration member, and a vibration generating apparatus configured to vibrate the vibration member. The vibration generating apparatus may include a first electrode layer, a second electrode layer, and a first vibration layer and a second vibration layer between the first electrode layer and the second electrode layer, the first vibration layer and the second vibration layer having different deformation characteristics from each other.

According to various example embodiments of the present disclosure, the vibration member may include one or more of a display panel including a plurality of pixels configured to display an image, a screen panel on which an image is to be projected from a display apparatus, an illumination panel, a signage panel, a vehicular interior material, a vehicular glass window, a vehicular exterior material, a vehicular ceiling material, a ceiling material of a building, an interior material of a building, a window of a building, an interior material of an aircraft, a glass window of an aircraft, or the vibration member may include one or more of materials among wood, plastic, glass, metal, cloth, fiber, paper, rubber, leather, carbon, and mirror.

It will be apparent to those skilled in the art that various modifications and variations may be made in the apparatus of the present disclosure without departing from the scope of the disclosure. Thus, it is intended that the present disclosure covers the modifications and variations of this disclosure that come within the scope of the claims and their equivalents.

What is claimed is:

1. A vibration apparatus, comprising:
a first electrode layer;
a second electrode layer; and
a first vibration layer and a second vibration layer between the first electrode layer and the second electrode layer, the first vibration layer and the second vibration layer having different deformation characteristics from each other.

2. The vibration apparatus of claim 1, wherein the different deformation characteristics comprise a phase transition deformation characteristic and an electric field induced deformation characteristic.

3. The vibration apparatus of claim 1, wherein the first vibration layer and the second vibration layer are stacked to overlap each other.

4. The vibration apparatus of claim 1, wherein the first vibration layer and the second vibration layer have different thicknesses from each other.

5. The vibration apparatus of claim 1, wherein the first vibration layer has a thickness which is thinner than a thickness of the second vibration layer.

6. The vibration apparatus of claim 1, wherein the first vibration layer and the second vibration layer have different volumes from each other.

7. The vibration apparatus of claim 6, wherein the first vibration layer has a volume which is smaller than a volume of the second vibration layer.

8. The vibration apparatus of claim 7, wherein the first vibration layer is composed of a volume of 40 vol % or less but greater than 0 vol % based on a total volume including the first vibration layer and the second vibration layer.

9. The vibration apparatus of claim 1, wherein:
the first vibration layer comprises a relaxor ferroelectric material; and
the second vibration layer comprises a ferroelectric material or a piezoelectric material.

10. The vibration apparatus of claim 9, wherein the first vibration layer comprises a bismuth (Bi)-based material.

11. The vibration apparatus of claim 9, wherein the second vibration layer comprises at least one of a lead zirconate titanate (PZT)-based material, a potassium sodium niobate (KNN)-based material, and a barium titanate (BT)-based material.

12. The vibration apparatus of claim 1, wherein:
the first vibration layer comprises a plurality of first vibration layers; and
the second vibration layer is between the plurality of first vibration layers and has a thickness greater than that of each of the plurality of first vibration layers.

13. The vibration apparatus of claim 1, wherein:
the second vibration layer comprises a plurality of second vibration layers; and
the first vibration layer is between the plurality of second vibration layers and has a thickness thinner than that of each of the plurality of second vibration layers.

14. The vibration apparatus of claim 1, wherein:
the first vibration layer comprises a plurality of first vibration layers;
the second vibration layer comprises a plurality of second vibration layers; and
the plurality of first vibration layers have a thickness which is equal to or thinner than a thickness of the plurality of second vibration layers, and the plurality of first vibration layers are composed of a same number or less than that of the plurality of second vibration layers.

15. The vibration apparatus of claim 1, further comprising a middle electrode layer disposed between the first vibration layer and the second vibration layer.

16. The vibration apparatus of claim 1, further comprising a signal supply member configured to supply a driving signal, supplied from a driving circuit, to the first electrode layer and the second electrode layer.

17. The vibration apparatus of claim 16, wherein the signal supply member comprises a base member and a plurality of signal lines.

18. The vibration apparatus of claim 17, wherein ends of the plurality of signal lines are connected with the respective first electrode layer and the second electrode layer.

19. An apparatus, comprising:
a vibration member; and
a vibration generating apparatus configured to vibrate the vibration member,
wherein the vibration generating apparatus comprises the vibration apparatus of claim 1.

20. The apparatus of claim 19, wherein the vibration member comprises one or more of a display panel including a plurality of pixels configured to display an image, a screen panel on which an image is to be projected from a display apparatus, an illumination panel, a signage panel, a vehicular interior material, a vehicular glass window, a vehicular exterior material, a vehicular ceiling material, a ceiling material of a building, an interior material of a building, a window of a building, an interior material of an aircraft, a glass window of an aircraft, or
wherein the vibration member comprises one or more of materials among wood, plastic, glass, metal, cloth, fiber, paper, rubber, leather, carbon, and mirror.
